(19) United States
(12) Patent Application Publication
(10) Pub. No.: US 2013/0138390 A1
(43) Pub. Date: May 30, 2013

(54) WALKING DIRECTION DETECTION DEVICE AND WALKING DIRECTION DETECTION METHOD

(71) Applicant: Yukio Shikatani, Kanagawa (JP)

(72) Inventor: Yukio Shikatani, Kanagawa (JP)

(73) Assignee: Panasonic Corporation, Osaka (JP)

(21) Appl. No.: 13/814,762

(22) PCT Filed: Jun. 29, 2011
(86) PCT No.: PCT/JP2011/003708

§ 371 Date: Feb. 7, 2013

(30) Foreign Application Priority Data
Aug. 10, 2010 (JP) 2010-179487

(51) Int. Cl. G01C 21/10; G06F 17/00

(52) U.S. Cl. CPC G01C 21/10; G06F 17/00
USPC 702/141

(57) ABSTRACT

Provided is a walking azimuth detection device capable of quickly and accurately detecting a walking azimuth at the start of walker's walking. The device (700) detects a walking azimuth of a person and has an acceleration component calculation unit (730) for obtaining a vertical component and a horizontal component of an acceleration of the person and a walking azimuth calculation unit (770) for determining the walking azimuth on the basis of the time sequence data of the vertical component and the horizontal component. When the vertical component becomes local minimum immediately after the person has been in a stop state, the walking azimuth calculation unit (770) takes the direction of the acceleration as the walking azimuth.

### TECHNICAL FIELD

The claimed invention relates to a walking azimuth detecting apparatus and a walking azimuth detecting method for detecting a walking azimuth of a person.

### BACKGROUND ART

A technique is desired which warns a pedestrian when a vehicle approaches the direction in which the pedestrian walks or when a traffic light in the direction in which the pedestrian walks is red. In order to achieve such a technique, an azimuth of the direction in which the pedestrian walks (hereinafter, referred to as “walking azimuth.”) must be detected.

A possible method of detecting a walking azimuth involves calculating the walking azimuth from global positioning system (GPS) information of the pedestrian.

Another possible method involves using a technique of detecting the walking azimuth by performing dead reckoning using an acceleration sensor and an azimuth sensor that are attached to pedestrian's portable article, such as, a mobile telephone (see, e.g., Patent Literature 1). The technique described in Patent Literature 1 acquires a vertical component and horizontal component of acceleration of motion of a person with reference to the results measured by the acceleration sensor and the results measured by the azimuth sensor. The technique described in Patent Literature 1 defines the direction of the acceleration of a part, in which the horizontal component reaches a maximum value when the vertical component reaches a local minimum value immediately after a maximum value, as the walking azimuth.

A walking azimuth of a pedestrian can be detected according to such conventional techniques.

### CITATION LIST

### Patent Literature

### PTL 1

Japanese Patent Application Laid-Open No. 2003-302419

### SUMMARY OF INVENTION

### Technical Problem

However, there is a problem that the above-mentioned conventional technique cannot quickly and precisely detect a walking azimuth of a pedestrian when the pedestrian starts walking.

This is because the technique using GPS information cannot precisely detect the walking azimuth unless the pedestrian walks a few meters, in consideration of the accuracy for measuring the pedestrian's position and the delay time until the position is acquired.

In addition, the technique described in Patent Literature 1 relates to detection of the walking azimuth for an action during walk, and thus the timing for detecting the walking azimuth is delayed even when the technique is applied to detection of the walking azimuth to which the pedestrian starts walking.

For example, a case where a bicycle jumps out from a road side when a traffic light turns green and then a pedestrian starts to cross a crosswalk is possible. In such a case, the walking azimuth must be detected as quickly and accurately as possible so as to effectively warn the pedestrian. For this reason, a technique is desired, the technique capable of detecting the walking azimuth, to which the pedestrian starts walking, as quickly and precisely as possible.

It is an object of the claimed invention to provide a walking azimuth detecting apparatus and a method of detecting a walking azimuth that can quickly and precisely detect a walking azimuth to which a pedestrian starts walking.

### Solution to Problem

A walking azimuth detecting apparatus of the claimed invention that detects a walking azimuth of a person, the apparatus includes: an acceleration component calculating section that acquires a vertical component and a horizontal component of acceleration of motion of the person; and a walking azimuth calculating section that calculates the walking azimuth based on time series data of the vertical component and the horizontal component, where the walking azimuth calculating section defines an azimuth of the acceleration as the walking azimuth when the vertical component reaches a local minimum value immediately after the person is in a stopped state.

A method of detecting a walking azimuth of the claimed invention that detects a walking azimuth of a person, the method includes the steps of: acquiring a vertical component and a horizontal component of an acceleration of motion of the person determining whether or not the vertical component reaches a local minimum value immediately after the person is in a stopped state, based on time series data of the vertical component and the horizontal component; and determining that an azimuth of the acceleration is the walking azimuth when the vertical component reaches the local minimum value immediately after the person is in the stopped state.

### Advantageous Effects of Invention

According to the claimed invention, a walking azimuth to which a pedestrian starts walking can be quickly and precisely detected.

### BRIEF DESCRIPTION OF DRAWINGS

FIG. 1 is a system configuration diagram showing a configuration of a walking azimuth detecting apparatus according to Embodiment 1 of the claimed invention;

FIG. 2 is a block diagram showing an example configuration of a mobile telephone and a base station according to Embodiment 1 of the claimed invention;

FIG. 3 is a block diagram showing an example configuration of a walking azimuth detecting apparatus according to Embodiment 1 of the claimed invention;

FIG. 4 shows an example state of attaching an acceleration sensor and an azimuth sensor according to Embodiment 1 of the claimed invention;

FIG. 5 is a block diagram showing an example configuration of an acceleration component calculating section and a walking direction calculating section according to Embodiment 1 of the claimed invention;

FIG. 6 explains each component of acceleration according to Embodiment 1 of the claimed invention;

FIG. 7 explains the effect of the walking azimuth detecting apparatus according to Embodiment 1 of the claimed invention;

FIG. 8 is a flowchart showing the overall operation of the walking azimuth detecting apparatus according to Embodiment 1;

FIG. 9 is a sequence diagram showing an information flow among processes of the walking azimuth detecting apparatus according to Embodiment 1 of the claimed invention;

FIG. 10 shows an example format of measured acceleration data according to Embodiment 1 of the claimed invention;

FIG. 11 shows an example format of measured azimuth direction data according to Embodiment 1 of the claimed invention;

FIG. 12 shows an example absolute value graph of the measured acceleration data according to Embodiment 1 of the claimed invention;

FIG. 13 shows a terminal coordinate system according to Embodiment 1 of the claimed invention;

FIG. 14 is the first diagram for explaining a tilt angle according to Embodiment 1 of the claimed invention;

FIG. 15 is the second diagram for explaining the tilt angle according to Embodiment 1 of the claimed invention;

FIG. 16 is the third diagram for explaining the tilt angle according to Embodiment 1 of the claimed invention;

FIG. 17 explains an example judgment condition of a stopped state according to Embodiment 1 of the claimed invention;

FIG. 18 is a flowchart showing an example process determining the start of walk according to Embodiment 1 of the claimed invention;

FIG. 19 is a flowchart showing an example maximum/minimum detecting process according to Embodiment 1 of the claimed invention;

FIG. 20 explains predetermined characteristics as a target of detection from a horizontal component according to Embodiment 1 of the claimed invention;

FIG. 21 is a flowchart showing an example process calculating a walking angle according to Embodiment 1 of the claimed invention;

FIG. 22 shows an example state of detecting a maximum point of the horizontal component according to Embodiment 1 of the claimed invention;

FIG. 23 shows the definition of a walking direction according to Embodiment 1 of the claimed invention;

FIG. 24 shows an example algorithm of determining the walking direction according to Embodiment 1 of the claimed invention;

FIG. 25 shows the definition of an apparatus direction according to Embodiment 1 of the claimed invention;

FIG. 26 shows an example algorithm of determining the apparatus direction according to Embodiment 1 of the claimed invention;

FIG. 27 shows the definition of the walking azimuth and an algorithm determining the walking azimuth according to Embodiment 1 of the claimed invention; and

FIG. 28 shows an example process determining the start of walk according to Embodiment 2 of the claimed invention.

### DESCRIPTION OF EMBODIMENT

Hereinafter, Embodiment 1 of the claimed invention will be described in detail with reference to the drawings.

### Embodiment 1

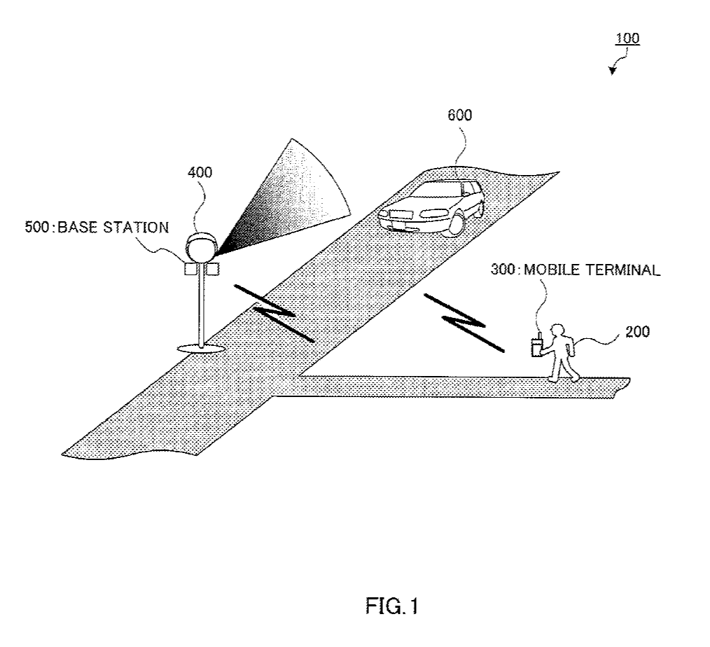

FIG. 1 is a system configuration diagram showing a configuration of a walking azimuth detecting apparatus according to one embodiment of the claimed invention;

in FIG. 1, warning system 100 includes mobile terminal 300 carried by pedestrian 200 and base station 500 attached to structure 400 such as a road mirror arranged around the town, for example.

Mobile terminal 300 is an apparatus that includes a walking azimuth detecting apparatus according to the claimed invention, and is, e.g., a mobile telephone. In mobile terminal 300, a walking azimuth detecting apparatus detects the position and walking direction of mobile terminal 300 (i.e., pedestrian) and successively transmits the result to nearby base station 500, by radio.

In the present embodiment, mobile terminal 300 treats, as the detection object, only the walking direction in which the pedestrian starts walking from the state in which pedestrian 200 stands still.

Base station 500 detects movable body 600 approaching base station 500 (e.g., a vehicle or a bicycle), using a sensor, e.g., a camera or a radar. Base station 500 determines the necessity of a warning to pedestrian 200, based on the detection result and information of the position and walking direction of pedestrian 200, the information being received from mobile terminal 300. Base station 500 warns pedestrian 200 of the approach of movable body 600 when determining that the warning is necessary.

The warning may be performed by speech or light outputted from base station 500 or by speech, light, or vibration outputted from mobile terminal 300. In this case, the warning is performed by transmission of warning information from base station 500 to mobile terminal 300 and output of speech from mobile terminal 300.

Such warning system 100 can warn pedestrian 200 of the approach of movable body 600 that pedestrian 200 cannot visually confirm due to a blind spot of a street corner, for example. Consequently, warning system 100 can prevent a minor accident between pedestrian 200 and movable body 600 in advance. In other words, warning system 100 can ensure safety of pedestrian 200 with reference to a walking azimuth to which pedestrian 200 starts walking.

The configuration of each apparatus will now be explained.

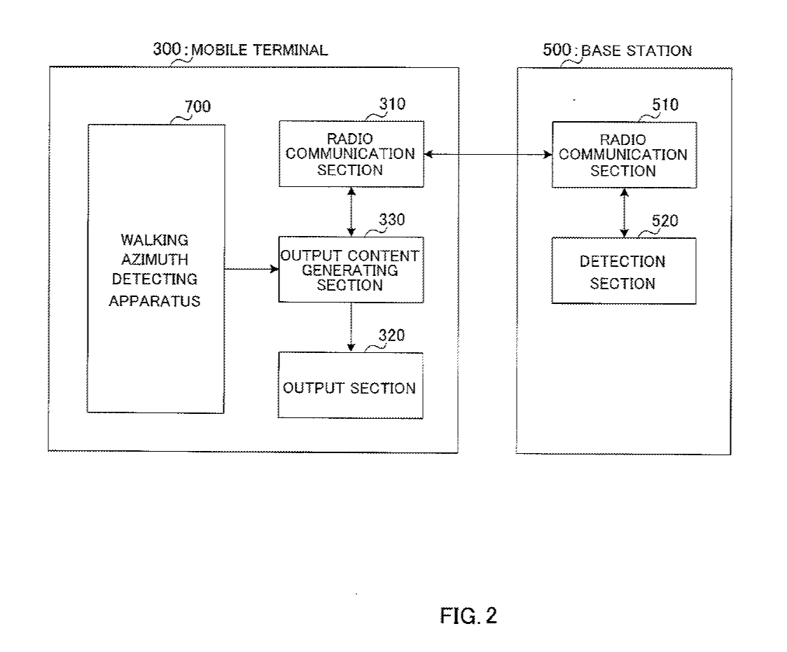

FIG. 2 is a block diagram showing an example configuration of mobile terminal 300 and base station 500.

In FIG. 2, mobile terminal 300 includes radio communication section 310, output section 320, output content generating section 330, and walking azimuth detecting apparatus 700 according to the claimed invention.

Radio communication section 310 performs bidirectional radio communication with nearby base station 500.

Output section 320 includes an image display apparatus, e.g., a liquid crystal display, and a speech output apparatus, e.g., a loudspeaker, and outputs an image and speech.

Output content generating section 330 generates content (warning alarm in this embodiment) to be outputted to pedestrian 200 (hereinafter, referred to as “output content”), based on walking direction information generated by a walking azimuth detecting apparatus (described hereinafter) and warning information received from base station 500 through radio communication section 310. Then, output content generating section 330 outputs the generated output content to pedestrian 200 through output section 320.

Walking azimuth detecting apparatus 700 detects a walking azimuth of pedestrian 200. Specifically, the azimuth of acceleration of pedestrian 200 is determined as the walking azimuth when a vertical component of the acceleration of pedestrian 200 reaches a local minimum value immediately after pedestrian 200 is in a stopped state. The definition of the stopped state will be hereinafter described. Every time the walking azimuth is detected, walking azimuth detecting apparatus 700 transmits walking azimuth information including the walking azimuth to base station 500 through output content generating section 330 and radio communication section 310.

Such mobile terminal 300 can detect and transmit the walking azimuth to base station 500 when the vertical component of the acceleration of pedestrian 200 reaches the local minimum value immediately after pedestrian 200 is in the stopped state. This detection timing is earlier than the detection timing of the walking azimuth according to the technique described in Patent Literature 1, which will be hereinafter described.

In FIG. 2, base station 500 includes radio communication section 510 and detection section 520.

Radio communication section 510 performs bidirectional radio communication with nearby mobile terminal 300.

Detection section 520 detects movable body 600 approaching base station 500, using a sensor, e.g., a camera. When receiving the above-described walking azimuth information from mobile terminal 300 through radio communication section 510, detection section 520 adequately generates the warning information based on the detection result of movable body 600 and the received walking azimuth information. Specifically, when movable body 600 approaches the direction in which mobile terminal 300 (i.e., pedestrian 200) starts walking, detection section 520 generates the warning information for reporting the approach. Then, detection section 520 transmits the generated warning information to mobile terminal 300 through radio communication section 510.

Such base station 500 can perform adequate warning based on the walking azimuth detected by mobile terminal 300.

The configuration of walking azimuth detecting apparatus 700 will now be explained.

The details of the definition of each parameter used by walking azimuth detecting apparatus 700 and the calculation performed by walking azimuth detecting apparatus 700 will be hereinafter described.

Hereinafter, the coordinate system that predetermines the position and direction of mobile terminal 300 as the standard is referred to as “terminal coordinate system.” In addition, the coordinate system that predetermines the vertical direction and azimuth as the standard is referred to as “world coordinated system.”

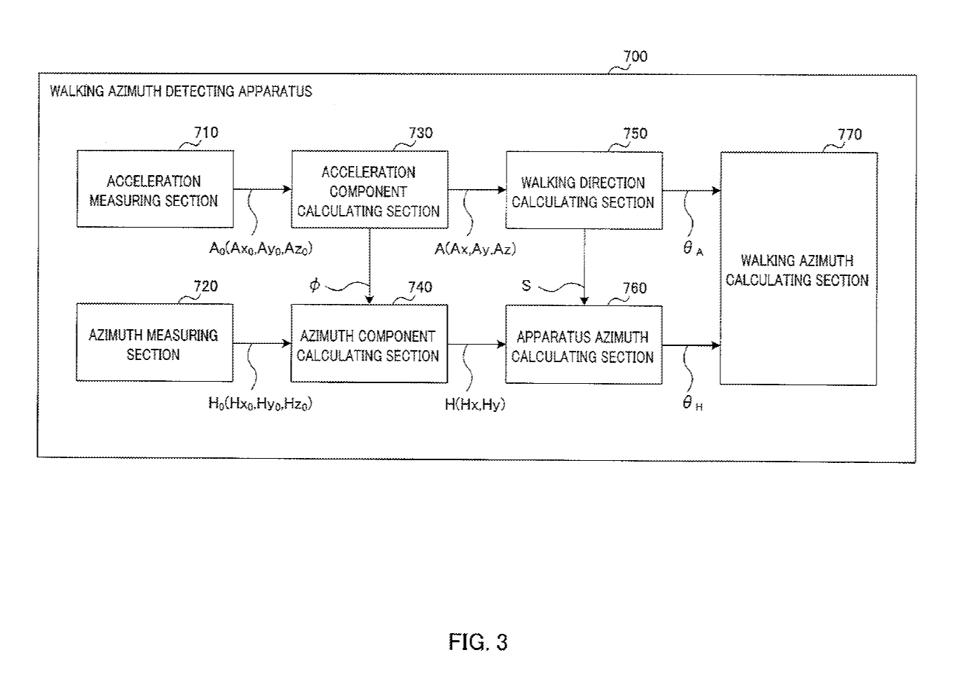

FIG. 3 is a block diagram showing an example configuration of walking azimuth detecting apparatus 700.

In FIG. 3, walking azimuth detecting apparatus 700 includes acceleration measuring section 710, azimuth measuring section 720, acceleration component calculating section 730, azimuth component calculating section 740, walking direction calculating section 750, apparatus azimuth calculating section 760, and walking azimuth calculating section 770.

Acceleration measuring section 710 includes an acceleration sensor and measures acceleration A₀ (Ax₀, Ay₀, Az₀) applied to mobile terminal 300 in the terminal coordinate system. Acceleration measuring section 710 then holds acceleration A₀ (Ax₀, Ay₀, Az₀) during 1.0 a certain interval of time.

In the present embodiment, mobile terminal 300 is put in a breast pocket of clothes of pedestrian 200, for example, and the acceleration applied to mobile terminal 300 is the same as the acceleration applied to pedestrian 200. Thus, acceleration measuring section 710 measures acceleration A₀ (Ax₀, Ay₀, Az₀) applied to mobile terminal 300 as the acceleration applied to pedestrian 200.

Azimuth measuring section 720 includes a magnetic field sensor and measures azimuth direction H₀ (Hx₀, Hy₀, Hz₀) in the terminal coordinate system. Azimuth measuring section 720 then holds azimuth direction H₀ (Hx₀, Hy₀, Hz₀) during a certain interval of

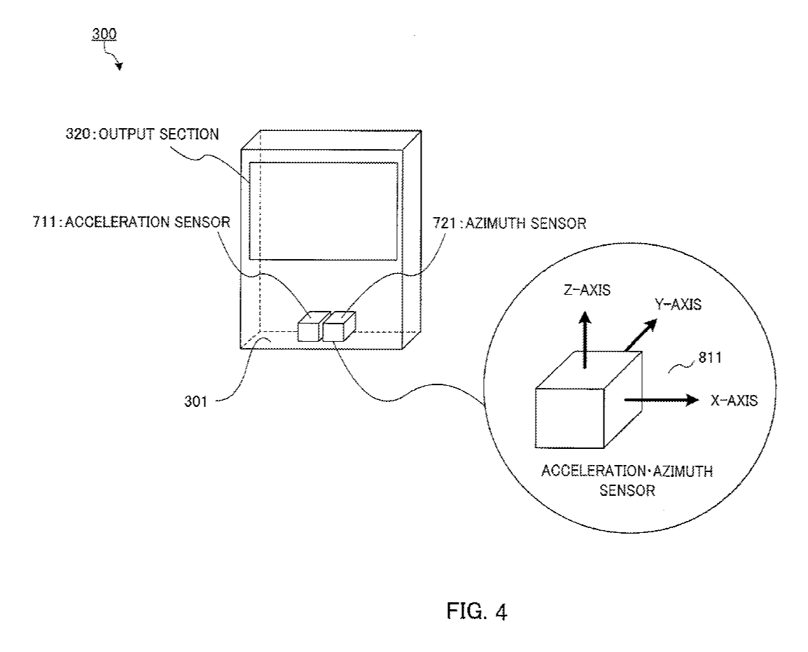

FIG. 4 shows an example mounting state of an acceleration sensor and an azimuth sensor.

As shown in FIG. 4, acceleration sensor 711 and azimuth sensor 721 are attached to housing 301 of mobile terminal 300. The positional relationship between acceleration sensor 711 and azimuth sensor 721 is fixed by being attached to housing 301, for example. Alternatively, the positional relationship between acceleration sensor 711 and azimuth sensor 721 is fixed by being directly attached to each other or be being integrated. Terminal coordinate system 811 composed of X-, Y-, and Z-axes uses acceleration sensor 711 or azimuth sensor 721 as the standard.

Acceleration component calculating section 730 in FIG. 3 calculates tilt angle φ of the terminal coordinate system in relation to the world coordinate system, based on data of acceleration A₀ (Ax₀, Ay₀, Az₀) measured by acceleration measuring section 710. Hereinafter, acceleration A₀ measured by acceleration measuring section 710 is adequately referred to as “measured acceleration data.” Acceleration component calculating section 730 calculates acceleration A (Ax, Ay, Az) of mobile terminal 300 in the world coordinate system, based on tilt angle φ and the measured acceleration data, provided that acceleration A (Ax, Ay, Az) of mobile terminal 300 represents values in which components of gravitational acceleration are removed from acceleration A₀.

Azimuth component calculating section 740 acquires data of azimuth direction H₀ (Hx₀, Hy₀, Hz₀) measured by azimuth measuring section 720 (hereinafter, adequately referred to as “measured azimuth direction data”) and tilt angle φ calculated by acceleration component calculating section 730. Azimuth component calculating section 740 calculates horizontal component H (Hx, Hy) of the azimuth direction in the world coordinate system, based on the measured azimuth direction data and tilt angle φ.

Walking direction calculating section 750 calculates walking direction (i.e., angle) θ_{A} in the terminal coordinate system, based on acceleration A (Ax, Ay, Az) of mobile terminal 300 calculated by acceleration component calculating section 730. Walking direction calculating section 750 determines, one after another, whether or not pedestrian 200 is in a stopped state, and outputs stopped-state determined notification S when determining that pedestrian 200 is in the stopped state.

When receiving stopped-state determined notification S as input, apparatus azimuth calculating section 760 calculates apparatus azimuth (i.e., direction of body of mobile terminal 300) θ_{H} in the world coordinate system, based on horizontal component H (Ex, Hy) of the azimuth direction calculated by azimuth component calculating section 740.

Walking azimuth calculating section 770 calculates walking azimuth (i.e., angle) θ based on walking direction θ_{A} calculated by walking direction calculating section 750 and apparatus azimuth (i.e., angle) θ_{H} calculated by apparatus azimuth calculating section 760.

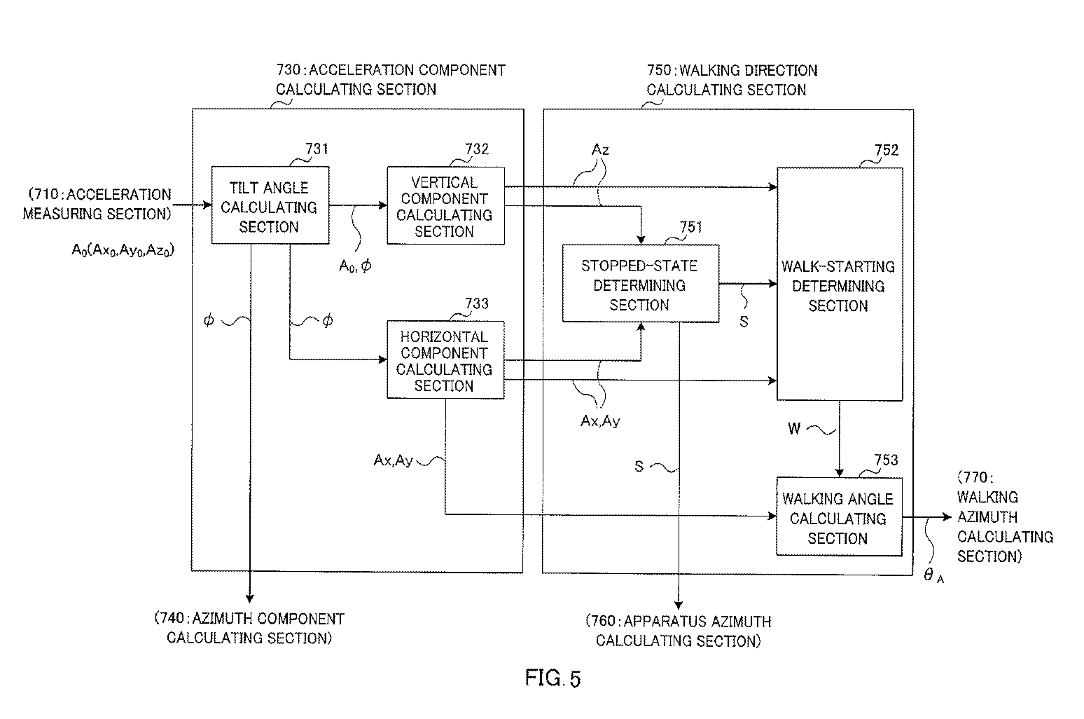

FIG. 5 is a block diagram showing an example configuration of acceleration component calculating section 730 and walking direction calculating section 750.

Acceleration component calculating section 730 includes tilt angle calculating section 731, vertical component calculating section 732, and horizontal component calculating section 733.

Tilt angle calculating section 731 calculates the above described tilt angle φ, based on data of acceleration A₀ (Ax₀, Ay₀, Az₀) (i.e., measured acceleration data) measured by acceleration measuring section 710.

Vertical component calculating section 732 calculates vertical component Az of acceleration A of mobile terminal 300, based on tilt angle φ calculated by tilt angle calculating section 731 and acceleration A₀ (Ax₀, Ay₀, Az₀).

Horizontal component calculating section 733 calculates horizontal components Ax and Ay of acceleration A of mobile terminal 300, based on tilt angle φ calculated by tilt angle calculating section 731 and acceleration A₀ (Ax₀, Ay₀, Az₀).

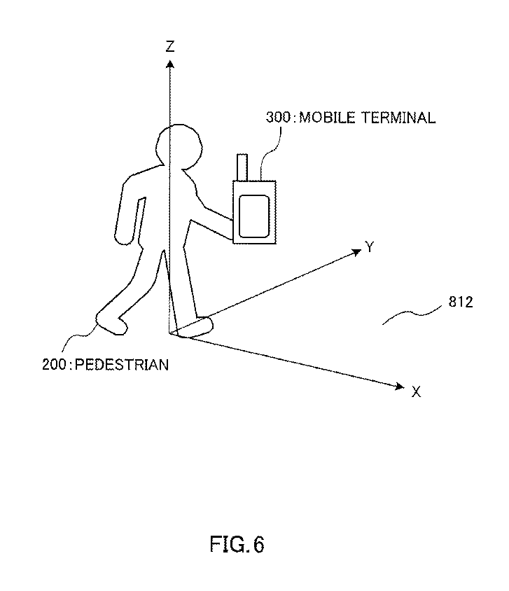

FIG. 6 explains vertical component Az and horizontal components Ax and Ay of acceleration A of mobile terminal 300.

As shown in FIG. 6, in world coordinate system 812 that uses a gravity direction and an azimuth as standards, Z-axis represents the vertical direction, and the X and Y directions represent horizontal directions. Vertical component Az of acceleration A refers to a component of acceleration A of mobile terminal 300 in the Z-axis direction in the world coordinate system. Horizontal components Ax and Ay of acceleration A refers to components of acceleration A of mobile terminal 300 in the X- and Y-axes directions in the world coordinate system, respectively. A combined component of horizontal components Ax and Ay is adequately referred to as “horizontal component Axy.”

Walking direction calculating section 750 in FIG. 5 includes stopped-state determining section 751, walk-starting determining section 752, and walking angle calculating section 753.

Stopped-state determining section 751 determines whether or not pedestrian 200 is in a stopped state, based on vertical component Az calculated by vertical component calculating section 732 and horizontal components Ax and Ay calculated by horizontal component calculating section 733. Then, when determining that pedestrian 200 is in the stopped state, stopped-state determining section 751 outputs stopped-state determined notification S to walk-starting determining section 752 and apparatus azimuth calculating section 760.

When receiving stopped-state determined notification S as input from stopped-state determining section 751, walk-starting determining section 752 determines whether or not pedestrian 200 starts walking. This determination is performed based on vertical component Az calculated by vertical component calculating section 732 and horizontal components Ax and Ay calculated by horizontal component calculating section 733.

Specifically, when the vertical component of the acceleration of pedestrian 200 reaches the local minimum value immediately after the input of stopped-state determined notification. S, walk-starting determining section 752 outputs walk-starting determined notification W to walking angle calculating section 753.

When receiving walk-starting determined notification W as input from walk-starting determining section 752, walking angle calculating section 753 calculates walking direction (i.e., angle) θ_{A} in the terminal coordinate system, based on horizontal components Ax and Ay calculated by horizontal component calculating section 733.

Thus, mobile terminal 300 having such a configuration can detect a walking azimuth when a vertical component of acceleration of pedestrian 200 reaches the local minimum value immediately after pedestrian 200 is in a stopped state.

The reason why walking azimuth detecting apparatus 700 can quickly and precisely detect a walking azimuth will now be described.

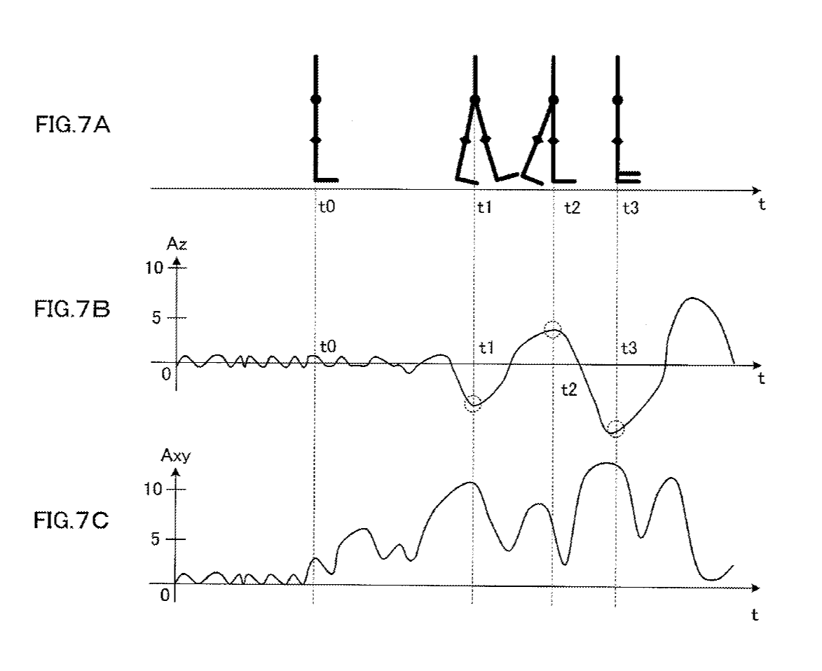

FIG. 7 explains why walking azimuth detecting apparatus 700 can quickly and precisely detect the walking azimuth.

As shown in FIG. 7A, pedestrian 200 stands, putting one's weight on both legs, in the initial state and starts to take a step at time t0. Pedestrian 200 kicks the ground by the back-side foot at time touches the front-side foot on the ground at time t2, and causes the back-side foot that kicked the ground to pass the side of the frond-side foot at time t3.

As shown in FIG. 7B, the inventor has found that vertical component Az of acceleration at the start of walking reaches the local minimum value at time t1, based on an experiment, in the present embodiment. In addition, as shown in FIG. 7C, the inventor has found a phenomenon in which the value of horizontal component Axy of the acceleration until immediately before time t1 gradually increases or fluctuates within a certain range, in the present embodiment. Hereinafter, such a phenomenon is referred to as “minute fluctuation phenomenon” and the interval where this phenomenon occurs is referred to as “minute fluctuation interval.”

Additionally, the inventor has found that a phenomenon in which vertical component Az reaches the local minimum value as shown in FIG. 7B at time t1, which is the time immediately after the minute fluctuation interval, is characteristic at the start of walking, in the present embodiment.

Thus, in the present embodiment, walking azimuth detecting apparatus 700 detects the walking azimuth when vertical component Az reaches the local minimum value immediately after a stopped state, as described above.

Time t1 is before time t2 which is when pedestrian 200 takes the second step. Accordingly, walking azimuth detecting apparatus 700 can detect the walking azimuth earlier than the technique described in Patent Literature 1.

In addition, the distance of a half-step is dozens of centimeters at most. Accordingly, walking azimuth detecting apparatus 700 can detect the walking azimuth earlier and more precisely than the above described technique using the GPS information.

The inventor has found that the minute fluctuation phenomenon occurs during an interval from the stopped state until vertical component Az reaches the local minimum value (i.e., interval until time t1), in the present embodiment. In other words, this found point represents the characteristic phenomenon at the start of walking. Accordingly, mobile terminal 300 of the present embodiment detects the walking azimuth provided that the minute fluctuation phenomenon occurs during an interval until vertical component Az reaches the local minimum value. Consequently, mobile terminal 300 of the present embodiment can improve detection accuracy.

In addition, the inventor has found that vertical component Az of the acceleration reaches the local maximum value at time t2, in the present embodiment. This represents the characteristic phenomenon at the start of walking. Accordingly, in the present embodiment, mobile terminal 300 detects the walking azimuth provided that vertical component Az reaches the local maximum value immediately after reaching the local minimum value, and thus improves the detection accuracy, as described hereinafter. Even in this case, walking azimuth detecting apparatus 700 can detect the walking azimuth at time t2 when pedestrian 200 takes the second step, which is earlier than the technique described in above Patent Literature 1.

Hereinafter, the operation of walking azimuth detecting apparatus 700 will be described.

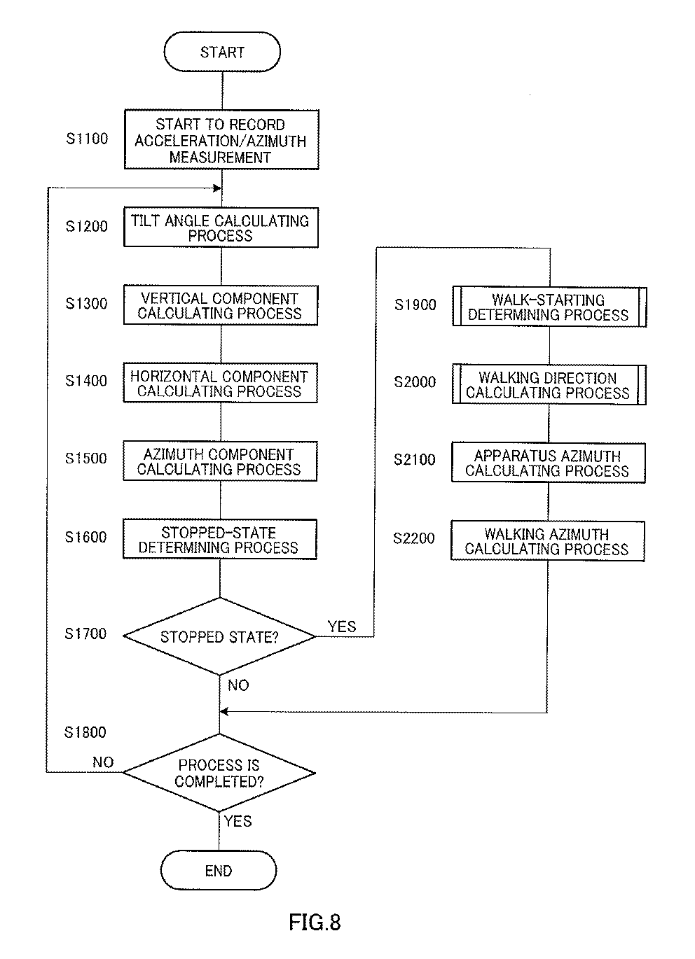

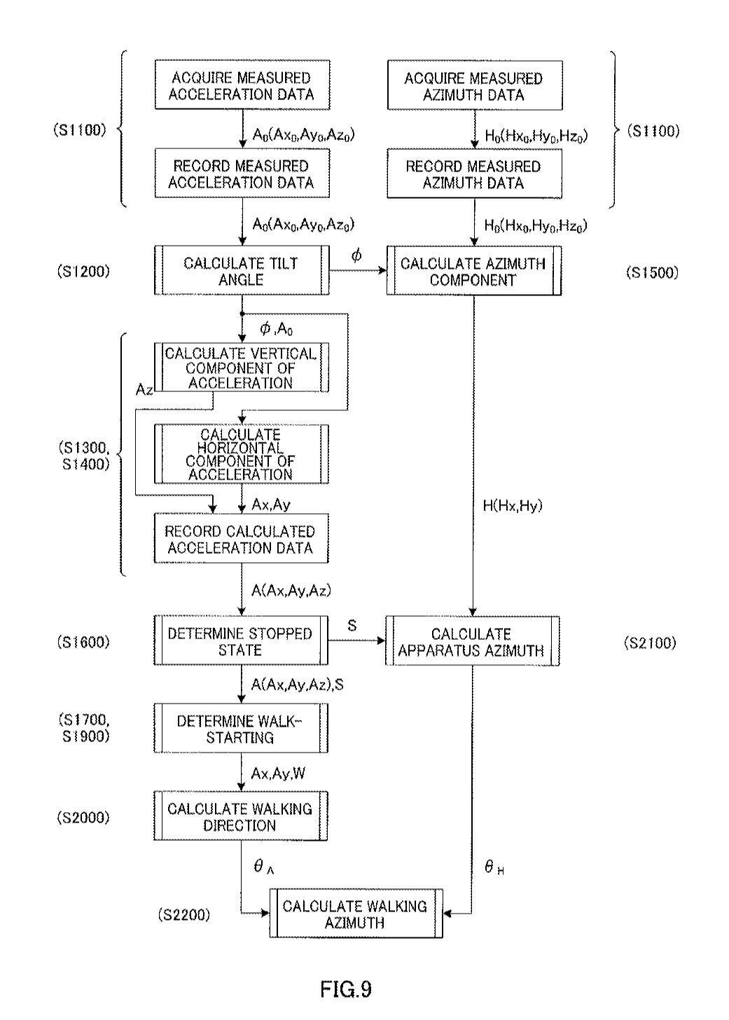

FIG. 8 is a flowchart showing the overall operation of walking azimuth detecting apparatus 700. FIG. 9 is a sequence diagram showing a information flow between processes of the walking azimuth detecting apparatus.

Walking azimuth detecting apparatus 700 performs processes of calculating a walking direction shown in the left side of FIG. 9 in parallel with processes of calculating an apparatus azimuth shown in the right side of FIG. 9, and finally calculates a walking azimuth based on the walking direction and the apparatus azimuth.

In step S1100, acceleration measuring section 710 and azimuth measuring section 720 start to measure acceleration A₀ and azimuth direction H₀, and records measured acceleration data and measured azimuth direction data at unit time intervals, respectively.

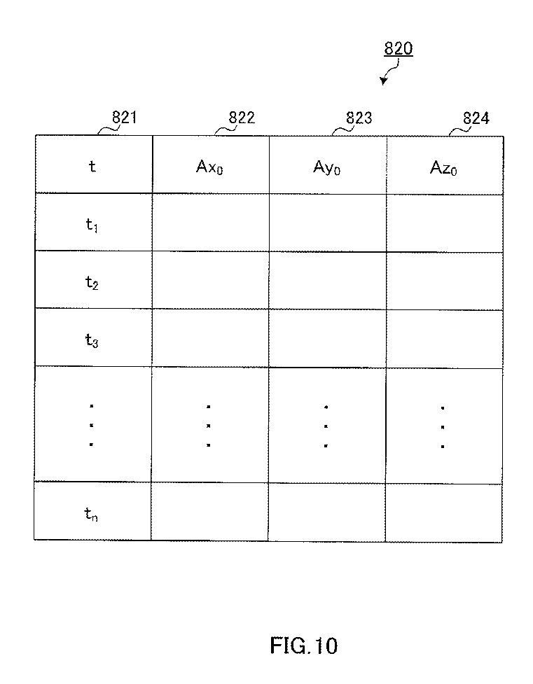

FIG. 10 shows an example format of measured acceleration data.

As shown in FIG. 10, X-axis component (Ax₀) 822, Y-axis component (Ay₀) 823, and Z-axis component (Az₀) 824 of acceleration. A₀ in the terminal coordinate system at each time (t) 821 having a predetermined interval are described as measured acceleration data 820.

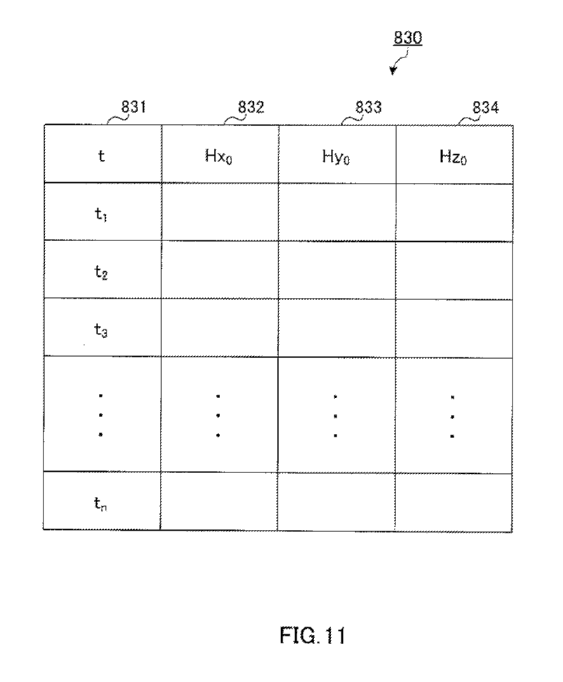

FIG. 11 shows an example format of measured azimuth direction data.

As shown in FIG. 11, X-axis component (Hx₀) 832, Y-axis component (Hy₀) 833, and Z-axis component (Hz₀) 834 of azimuth direction H₀ in the terminal coordinate system at each time (t) 831 having a predetermined interval are described as measured azimuth direction data 830.

In step S1200 of FIG. 8, tilt angle calculating section 731 performs a tilt angle calculating process to calculate tilt angle φ of the terminal coordinate system in relation to the world coordinate system. Specifically, tilt angle calculating section 731 calculates tilt angle φ as the following.

Tilt angle calculating section 731 calculates absolute value |Aa₀| of each acceleration A₀ of the measured acceleration data recorded by acceleration measuring section 710, based on following equation 1, for example.

[1]

|Aa₀|=\sqrt{Ax₀²+Ay₀²+Az₀²} (Equation 1)

Tilt angle calculating section 731 checks the fluctuation in absolute value |Aa₀| during last predetermined interval T₀ (e.g., three seconds) in time Tilt angle calculating section 731 then determines whether or not the current state is equal to the state where pedestrian 200 stands still and only gravitational acceleration g is applied to mobile terminal 300.

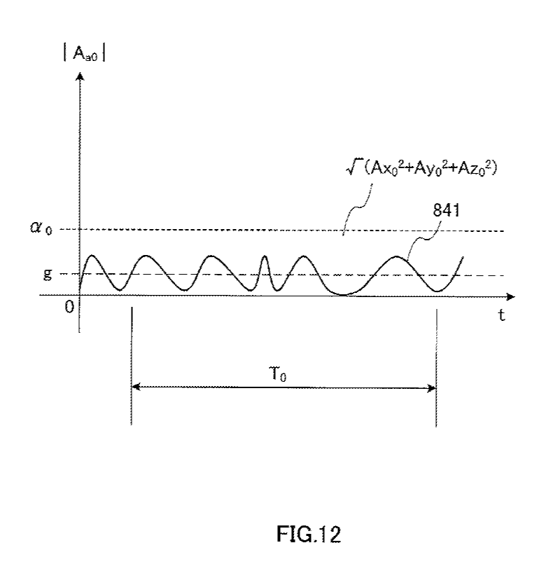

FIG. 12 shows an example absolute value graph of measured acceleration data.

Absolute value graph 841 on which absolute value |Aa₀| is graphically represented illustrates predetermined threshold α₀ or less while pedestrian 200 stands still, as shown in FIG. 12. The average value of absolute value |Aa₀| becomes a value close to gravitational acceleration g.

Tilt angle calculating section 731 defines the direction of average acceleration during time T₀ as a vertical direction, when the average value of absolute value |Aa₀| during time T₀ and absolute value |Aa₀| satisfy a certain condition. The certain condition refers to a case where a state, in which absolute value |Aa₀| is predetermined threshold α₀ or less, continues during predetermined time T₀, and the average value of absolute value |Az₀| during time T₀ is a value close to gravitational acceleration g. Tilt angle calculating section 731 then calculates tilt angle φ using the vertical direction as the standard.

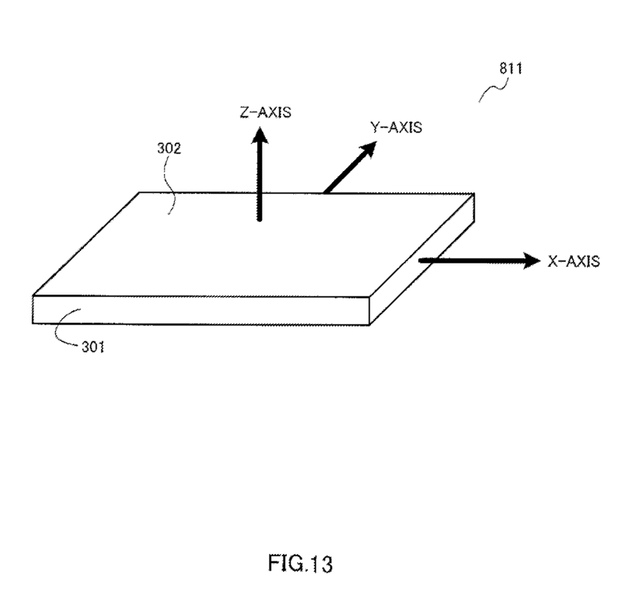

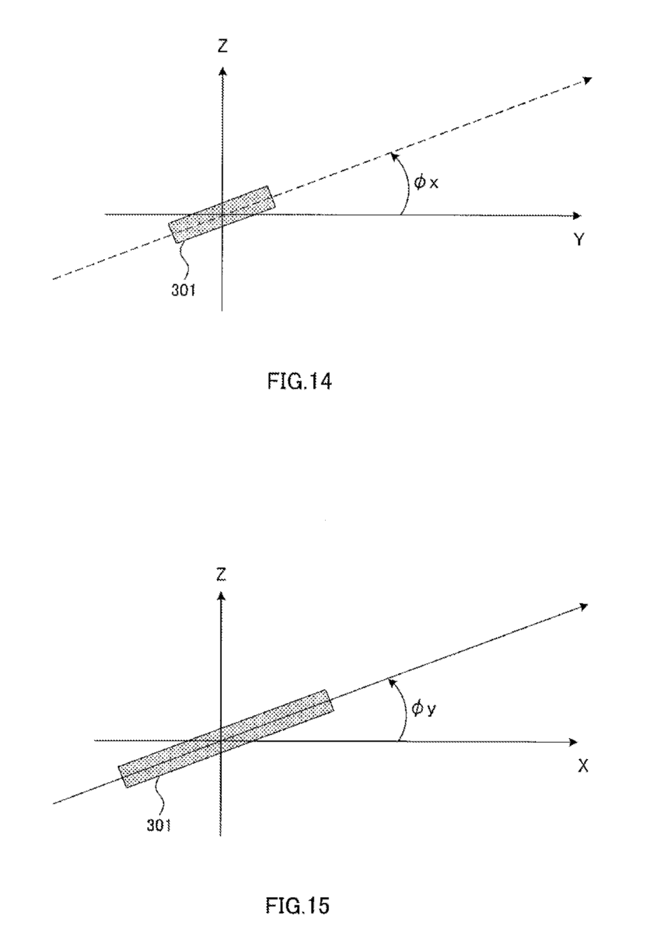

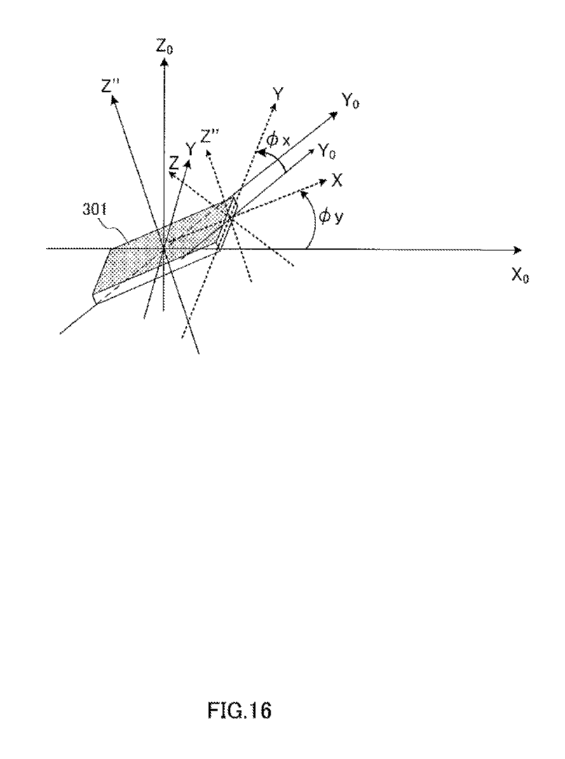

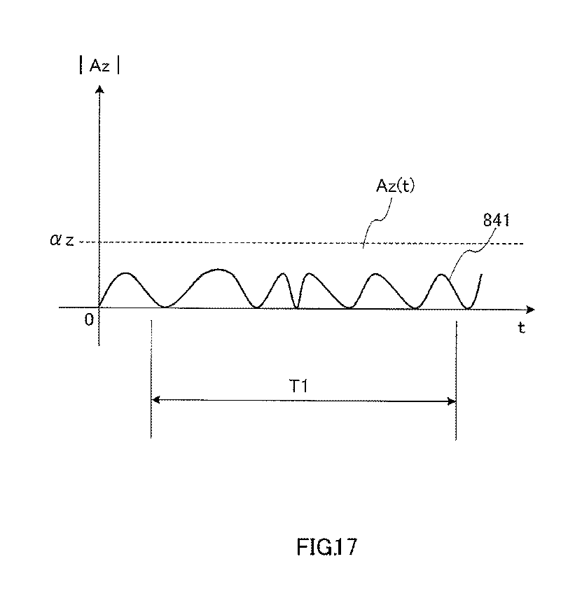

FIG. 13 shows a terminal coordinate system used for the following explanation. FIGS. 14 to 16 explain tilt angle φ.

As shown in FIG. 13, in terminal coordinate system 811, the normal direction of principal plane 302 of housing 301 of mobile terminal 300 is Z-axis, the longitudinal direction of housing 301 is X-axis, and the lateral direction of housing 301 is Y-axis, for example.

As shown in FIGS. 14 to 16, tilt angle calculating section 731 sets Z₀-axis of the world coordinate system in the vertical direction, and a X₀Y₀ plane on the basis of the Z₀-axis. Tilt angle calculating section 731 acquires rotation angle φx shown in FIG. 14 and rotation angle φy shown in FIG. 15 as tilt angle φ=(φx, φy). Rotation angle φx refers to the rotation angle around X-axis of the XY plane of the terminal coordinate system in relation to the X₀Y₀ plane shown in FIG. 14 Rotation angle φy refers to the rotation angle around Y-axis of the XY plane of the terminal coordinate system in relation to the X₀Y₀ plane shown in FIG. 15.

Specifically, tilt angle calculating section 731 calculates rotation angles φy and φx where Ax=Ay=0 and Az=g, using following equations 2 and 3, for example.

$$\begin{matrix}( Equation 2 ) & \\ ( \begin{matrix}Ax \\ {Az}^{″}\end{matrix} ) = ( \begin{matrix}cos {φ}_{y} & - sin {φ}_{y} \\ sin {φ}_{y} & cos {φ}_{y}\end{matrix} ) ( \begin{matrix}{Ax}_{0} \\ {Az}_{0}\end{matrix} ) & [ 2 ] \\ ( Equation 3 ) & \\ ( \begin{matrix}Ay \\ Az\end{matrix} ) = ( \begin{matrix}cos {φ}_{x} & - sin {φ}_{x} \\ sin {φ}_{x} & cos {φ}_{x}\end{matrix} ) ( \begin{matrix}{Ay}_{0} \\ {Az}^{″}\end{matrix} ) & [ 3 ]\end{matrix}$$

Tilt angle calculating section 731 outputs tilt angle φ=(φx, φy) to vertical component calculating section 732, horizontal component calculating section 733, and azimuth component calculating section 740.

In step S1300 of FIG. 8, vertical component calculating section 732 performs a vertical component calculating process of calculating vertical component Az of acceleration A of mobile terminal 300. Specifically, vertical component calculating section 732 calculates vertical component Az from acceleration A₀ (Ax₀, Ay₀, Az₀) and tilt angle φ=(φx, φy), using following equation 4, for example.

$$\begin{matrix}( Equation 4 ) & \\ \begin{matrix}Az = {Ay}_{0} * sin {φ}_{x} + {Az}^{″} * cos {φ}_{x} \\ = {Ay}_{0} * sin {φ}_{x} + ( {Ax}_{0} * sin {φ}_{y} + {Az}_{0} * cos {φ}_{y} ) * cos {φ}_{x}\end{matrix} & [ 4 ]\end{matrix}$$

Vertical component calculating section 732 outputs vertical component Az to stopped-state determining section 751 and walk-starting determining section 752.

In step S1400, horizontal component calculating section 733 performs a horizontal component calculating process of calculating horizontal components Ax and Ay of acceleration A of mobile terminal 300. Specifically, horizontal component calculating section 733 calculates horizontal components Ax and Ay from acceleration A₀ (Ax₀, Ay₀, Az₀) and tilt angle φ=((φx, φy), using following equations 5 and 6, for example.

$$\begin{matrix}( Equation 5 ) & \\ Ax = {Ax}_{0} * cos {φ}_{y} + {Az}_{0} * sin {φ}_{y} & [ 5 ] \\ ( Equation 6 ) & \\ \begin{matrix}Ay = {Ay}_{0} * cos {φ}_{x} + {Az}^{″} * sin {φ}_{x} \\ = {Ay}_{0} * cos {φ}_{x} - ( {Ax}_{0} * sin {φ}_{y} + {Az}_{0} * cos {φ}_{y} ) * sin {φ}_{x}\end{matrix} & [ 6 ]\end{matrix}$$

Horizontal component calculating section 733 outputs horizontal components Ax and Ay to stopped-state determining section 751 and walk-starting determining section 752.

In step S1500, azimuth component calculating section 740 performs an azimuth component calculating process of calculating horizontal component (Hx, Hy) of an azimuth direction. Specifically, azimuth component calculating section 740 calculates horizontal component H (Hx, Hy) of the azimuth direction based on azimuth direction H₀(Hx₀, Hy₀, Hz₀) and tilt angle φ=(φx, φy), using following equations 7 and 8, for example.

$$\begin{matrix}( Equation 7 ) & \\ Hx = {Hx}_{0} * cos {φ}_{y} + H {z}_{0} * sin {φ}_{y} & [ 7 ] \\ ( Equation 8 ) & \\ \begin{matrix}Hy = {Hy}_{0} * cos {φ}_{x} + H {z}^{″} * sin {φ}_{y} \\ = {Hy}_{0} * cos {φ}_{x} - ( {Hx}_{0} * sin {φ}_{y} + H {z}_{0} * cos {φ}_{y} ) * sin {φ}_{x}\end{matrix} & [ 8 ]\end{matrix}$$

Azimuth component calculating section 740 outputs horizontal component H (Hx, Hy) to apparatus azimuth calculating section 760.

In step S1600, stopped-state determining section 751 performs a stopped-state determining process of determining whether or not pedestrian 200 is in a stopped state. Specifically, stopped-state determining section 751 determines whether or not pedestrian 200 is in the stopped state, as the following, and adequately outputs stopped-state determined notification S.

FIG. 17 explains an example judgment condition of the stopped state.

As shown in FIG. 17, stopped-state determining section 751 determines that pedestrian 200 is in the stopped state when the state, where absolute value |Az| of vertical component Az of calculated acceleration data is predetermined threshold α_{z} or less, continues during predetermined interval T₁.

Pedestrian 200 may horizontally move by slipping. Thus, stopped-state determining section 751 may determine that pedestrian 200 is in the stopped state when equation 9 described below is valid. In this case, stopped-state determining section 751 determines that pedestrian 200 is in the stopped state, provided that the state, where absolute value |Axy| of horizontal component Axy of acceleration A is predetermined threshold oxy or less, continues during predetermined interval

[9]

\sqrt{Ax²+Ay²}≦αxy (Equation 9)

When stopped-state determining section 751 does not determine that pedestrian 200 is in the stopped state, in step S1700 (S1700: NO), the step moves to step S1800.

In step S1800, stopped-state determining section 751 determines whether or not completing the process is indicated by operator handling or the like. When stopped-state determining section 751 determines that completing the processes is not indicated (S1800: NO), the step returns to step S1200 and repeats the processes.

When determining that pedestrian 200 is in the stopped state (S1700: YES), stopped-state determining section 751 outputs stopped-state determined notification S to walk-starting determining section 752 and apparatus azimuth calculating section 760. As a result, the process moves to step S1900.

In step S1900 walk-starting determining section 752 performs a walk-starting determining process of determining whether or not pedestrian 200 starts walking after being in the stopped state.

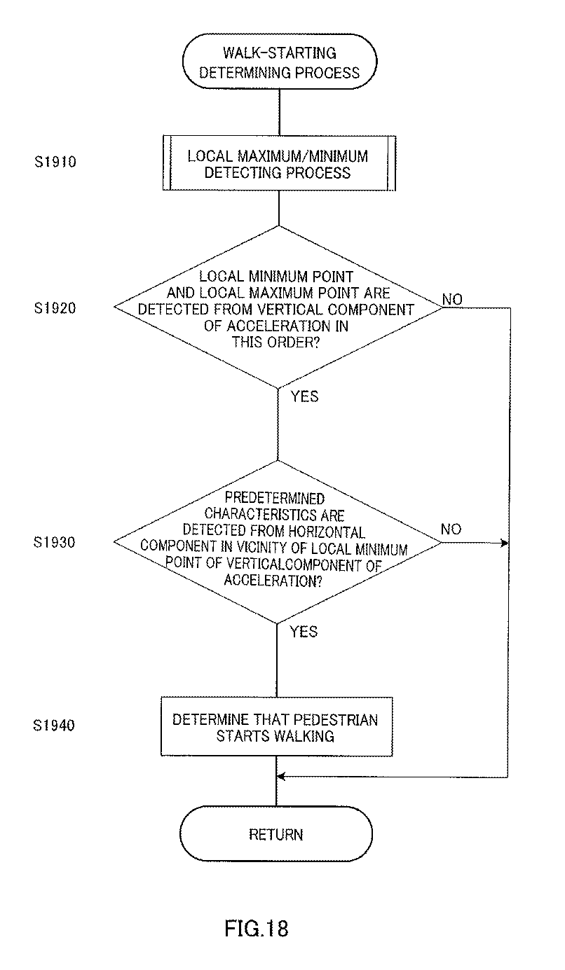

FIG. 18 is a flowchart showing an example walk-starting determining process.

Firstly, in step S1910, walk-starting determining section 752 performs a local maximum/minimum detecting process of detecting the local maximum/minimum value of vertical component Az of acceleration A of mobile terminal 300. The details of the local maximum/minimum detecting process will be hereinafter described.

In step S1920, walk-starting determining section 752 determines whether or not a local minimum point and a local maximum point are detected in this order from vertical component Az of acceleration A. When the local minimum point and the local maximum point are detected in this order (S1920: YES), walk-starting determining section 752 moves to step S1930. When the local minimum point and the local maximum point are not detected in this order (S1920: NO), walk-starting determining section 752 returns to the processes in FIG. 8.

In step S1930, walk-starting determining section 752 next determines whether or not the predetermined characteristics are detected from horizontal component Axy of the acceleration in the vicinity of the local minimum point of vertical component Az of the acceleration. The predetermined characteristics will be hereinafter described. When the predetermined characteristics are detected from horizontal component Axy (S1930: YES), walk-starting determining section 752 moves to step S1940. When the predetermined characteristics are not detected from horizontal component Axy (S1930: NO), walk-starting determining section 752 returns to the processes in FIG. 8.

In step S1940, walk-starting determining section 752 determines that pedestrian 200 starts walking, outputs walk-starting determined notification W to walking angle calculating section 753, and returns to the processes in FIG. 8.

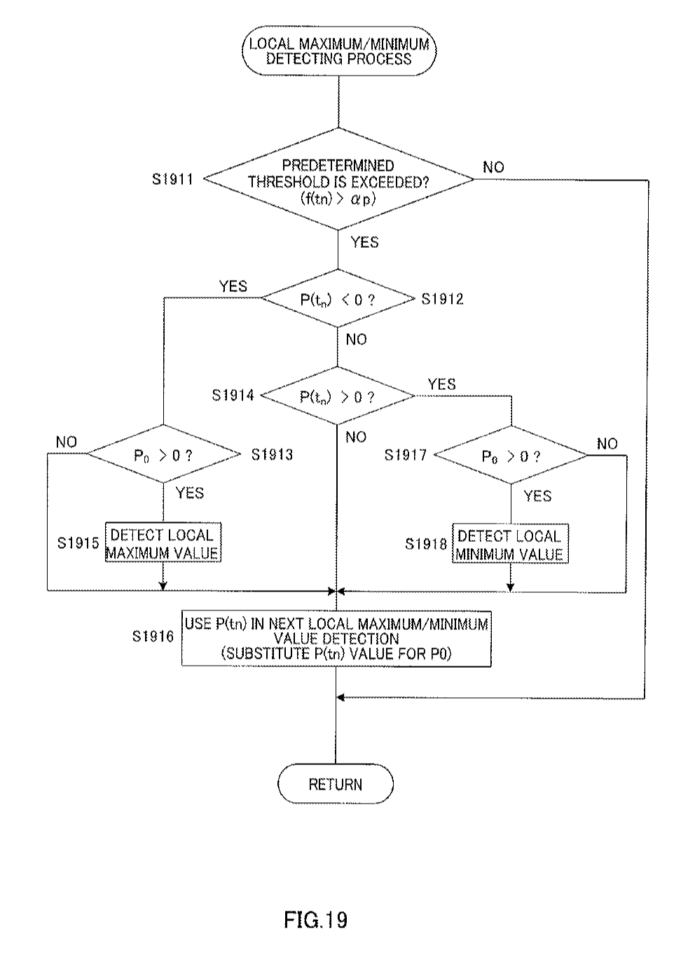

FIG. 19 is a flowchart showing an example local maximum/minimum detecting process. Previous to the process, walk-starting determining section 752 sets an initial value to variable P₀ prepared in advance.

In step S1911, walk-starting determining section 752 determines whether or not vertical component Az of the acceleration (hereinafter, referred to as “value f(t)”) exceeds predetermined threshold up. When value f(t) does not exceed threshold αp (S1911: NO), walk-starting determining section 752 returns to the processes in FIG. 18. When value f(t) exceeds threshold αp (S1911: YES), walk-starting determining section 752 moves to step S1912.

In step S1912, walk-starting determining section 752 calculates index value P(t) represented by following equation 10 and determines whether or not index value P(tₙ) is below 0. In other words, walk-starting determining section 752 determines whether or not vertical component Az fluctuates toward a decrease. When index value P(tₙ) is below 0 (S1912: YES), walk-starting determining section 752 moves to step S1913. When index value P(t) is not lower than 0 (S1912: NO), walk-starting determining section 752 moves to step S1914.

P(tₙ)=f(tₙ)−f(tₙ₋₁₎ (Equation 10)

In step S1913, walk-starting determining section 752 determines whether or not variable P₀ exceeds 0. When variable P₀ exceeds 0 (S1913: YES), walk-starting determining section 752 moves to step S1915. When variable P₀ is 0 or less (S1913: NO), walk-starting determining section 752 moves to step S1916.

In step S1915, walk-starting determining section 752 determines that vertical component Az of the acceleration reaches a local maximum value (i.e., detects a local maximum value), records the determination result, and moves to step S1916.

In step S1914, walk-starting determining section 752 determines whether or not index value P(t) exceeds 0. When index value P(tₙ) exceeds 0 (S1914: YES), walk-starting determining section 752 moves to step S1917. When index value P(t) does not exceed 0 (S1914: NO), walk-starting determining section 752 moves to step S1916.

In step S1917, walk-starling determining section 752 determines whether or not variable P₀ exceeds 0. When variable P₀ exceeds 0 (S1917: YES), walk-starting determining section 752 moves to step S1918. When variable P₀ is 0 or less (S1917: NO), walk-starting determining section 752 moves to step S1916.

In step S1918, walk-starting determining section 752 determines that vertical component Az of the acceleration reaches a local minimum value detects a local minimum value), records the determination result, and moves to step S1916.

In step S1916, walk-starting determining section 752 substitutes index value P(tₙ) for variable P₀, and returns to the processes in FIG. 18. In other words, walk-starting determining section 752 uses current index value P(tₙ) as a target of comparison in the next local maximum/minimum detecting process.

Walk-starting determining section 752 may detect the local maximum/minimum value after smoothing vertical component Az that is discrete time series data. This can remove noise and thus improve the accuracy to detect the timing when pedestrian 200 starts walking. By putting y=f(t)=Az, a three-point formula and a five-point formula of “y” are represented as following equations 11 and 12, for example, respectively, provided that “h” is an observation interval of “y.”

[11]

y(t)={y(x+h)−y(x−h)}/2h (Equation 11)

[12]

y(t)={y(x−2h)−8*y(x−h)−y(x+2h)}/12h (Equation 12)

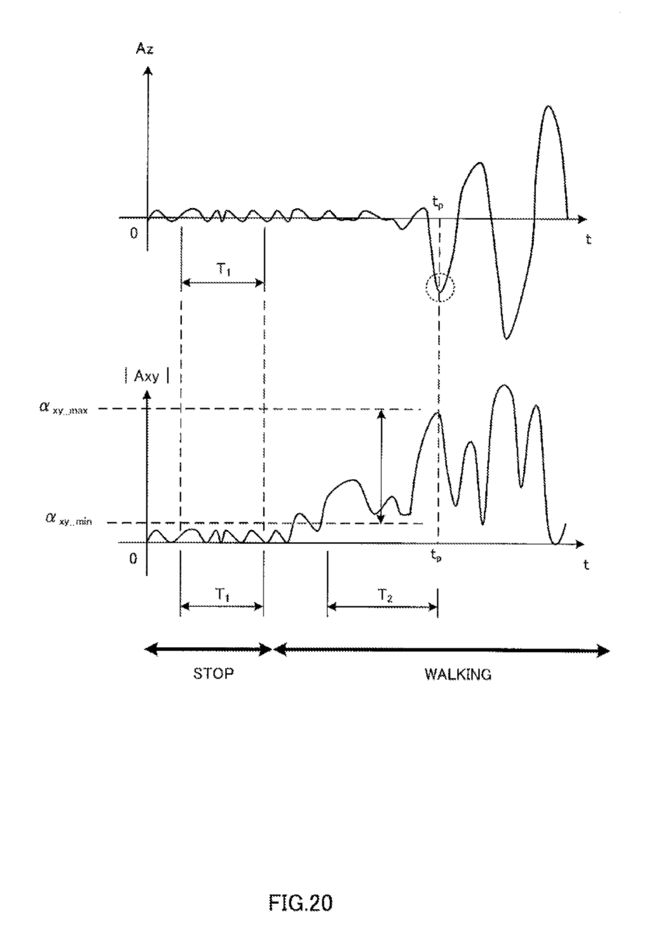

FIG. 20 explains predetermined characteristics as a target of detection from horizontal component Axy.

The above described predetermined characteristics refer to a case where at least one of the following first or second conditions is satisfied during an interval from when the stopped state is determined until time tₚ of the local minimum point of vertical component Az.

The first condition is that absolute value |Axy| of horizontal component Axy of acceleration A continues to be within the specified range defined by lower limit α_{xy}_{_{—}}ₘᵢₙ and upper limit α_{xy}_{_{—}}ₘₐₓ during a predetermined time T₂ or more. Note that the defined specified range represents the range of (α_{xy}_{_{—}}ₘᵢₙ<Axy<α_{xy}_{_{—}}ₘₐₓ).

The second condition is that the absolute value |Axy| of horizontal component Axy of acceleration A does not continues to be outside the specified range during a predetermined time interval or more. To be outside the specified range refers to being outside the specified range defined as (α_{xy}_{_{—}}ₘᵢₙ<Axy<α_{xy}_{_{—}}ₘₐₓ)

Upper limit α_{xy}_{_{—}}ₘₐₓ may be, for example, the value on the basis of a local maximum point of horizontal component Axy of acceleration A in the vicinity of time tₚ of a local minimum point of vertical component Az. Lower limit α_{xy}_{_{—}}ₘᵢₙ may be the value based on predetermined threshold α_{z} used in the stopped-state determining process.

In step S2000 of FIG. 8, walking angle calculating section 753 performs a walking angle calculating process of calculating walking direction θ_{A} in the terminal coordinate system.

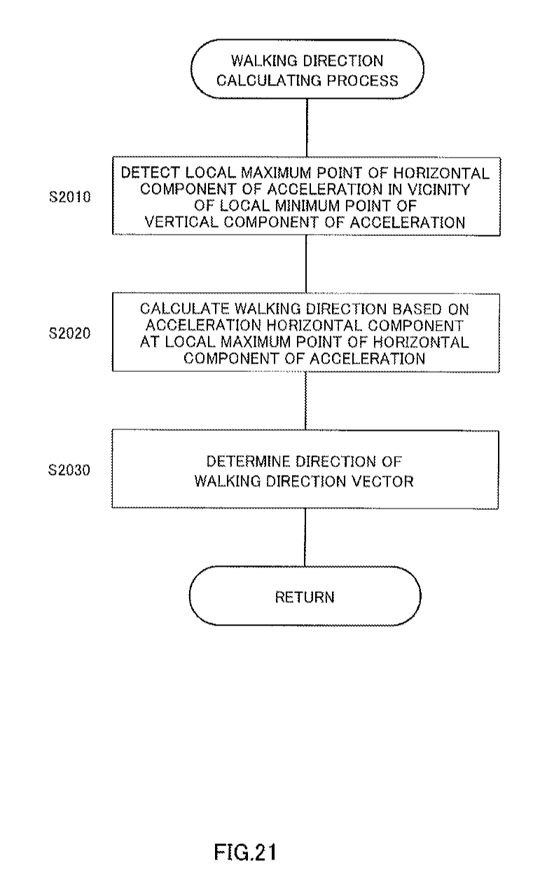

FIG. 21 is a flowchart showing an example process calculating a walking angle.

In step S2010, walking angle calculating section 753 detects a local maximum point of horizontal component Axy of the acceleration in the vicinity of a local minimum point of vertical component Az of the acceleration.

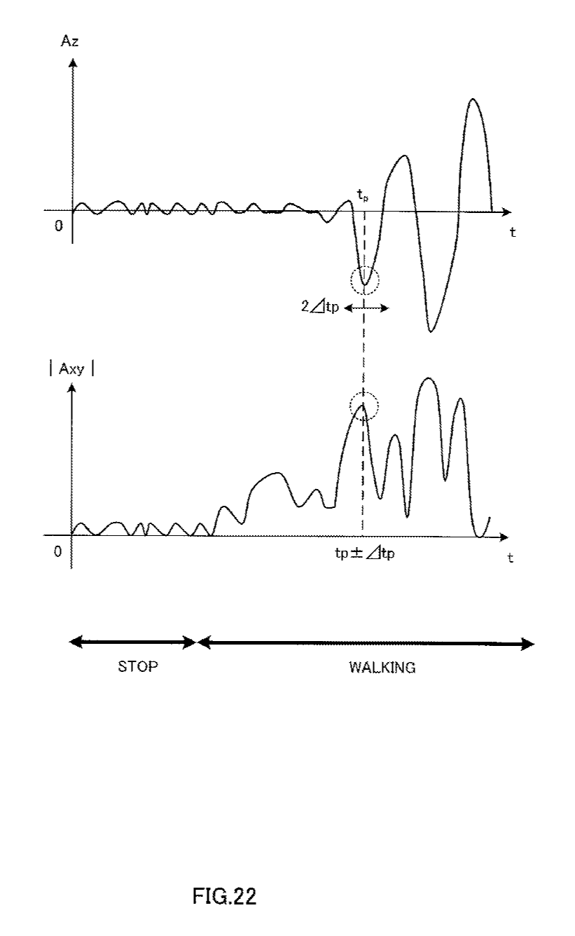

FIG. 22 shows an example state of detecting a local maximum point of horizontal component Axy of the acceleration.

Walking angle calculating section 753 detects a local maximum point of horizontal component Axy during an interval that has predetermined duration Δtₚ (i.e., tₚ−Δtₚ to tₚ+Δtₚ) on the basis of time tₚ of a local minimum point of vertical component Az, for example.

In step S2020 of FIG. 21, walking angle calculating section 753 calculates walking direction θ_{A} in the terminal coordinate system from horizontal component Axy at the detected local maximum point.

The inventor has found that pedestrian 200 starts walking in the direction of horizontal component Axy, when the timing of a local maximum point of horizontal component Axy is almost equal to the timing of a local minimum point of vertical component Az after the stopped state, in the present embodiment. Thus, when the timing of the local maximum point of horizontal component Axy of acceleration A is in the vicinity of the timing of the local minimum point of vertical component Az of acceleration A, walking angle calculating section 753 calculates walking direction θ_{A} using the direction of horizontal component Axy.

The inventor has also found that pedestrian 200 starts walking in the opposite direction of horizontal component Axy, when the timing of a local maximum point of horizontal component Axy is almost equal to the timing of a local maximum point of vertical component Az after the stopped state, in the present embodiment. Thus, when the timing of the local maximum point of horizontal component Axy of acceleration A is in the vicinity of the timing of the local maximum point of vertical component Az of acceleration A, walking angle calculating section 753 calculates walking direction θ_{A} using the opposite direction of horizontal component Axy.

In the following explanation, the timing of a local maximum point of horizontal component Axy is almost equal to the timing of a local minimum point of vertical component Az, and the direction of horizontal component Axy is used for calculating walking direction θ_{A}.

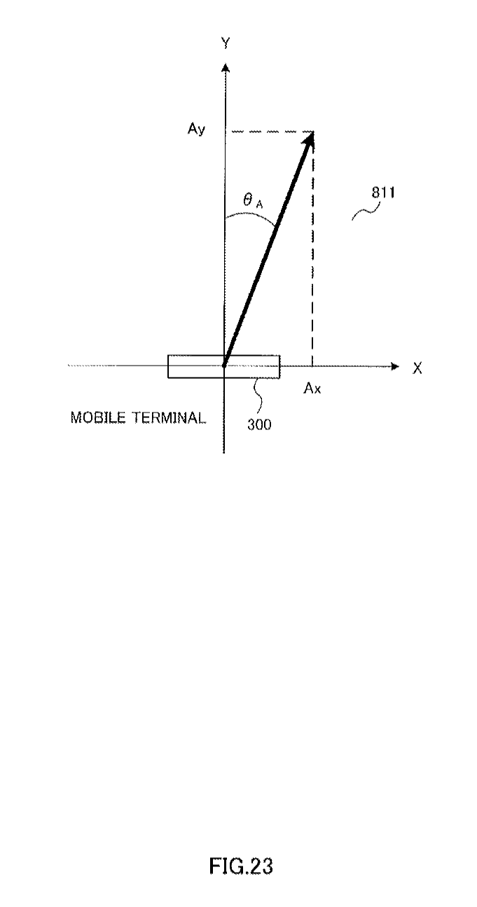

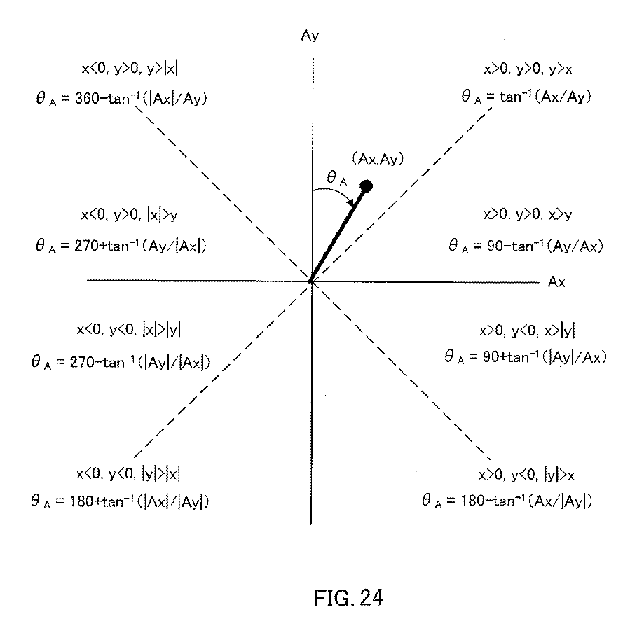

FIG. 23 shows the definition of walking direction θ_{A}. FIG. 241 shows an example algorithm of walking direction θ_{A}.

As shown in FIG. 23, walking direction θ_{A} represents the angle between the Y-axis positive direction and the direction of horizontal component Axy on an XY plane in terminal coordinate system 811, for example. Walking direction θ_{A} has a positive value in the clockwise direction as seen in the vertical direction, for example.

In step S2030 of FIG. 21, walking angle calculating section 753 determines that the direction represented by walking direction θ_{A} is the direction of a walking direction vector, Walking angle calculating section 753 outputs walking direction θ_{A} to walking azimuth calculating section 770, and returns to the processes in FIG. 8.

In step S2100 of FIG. 8, apparatus azimuth calculating section 760 performs an apparatus azimuth calculating process of calculating apparatus azimuth θ_{H} in the world coordinate system.

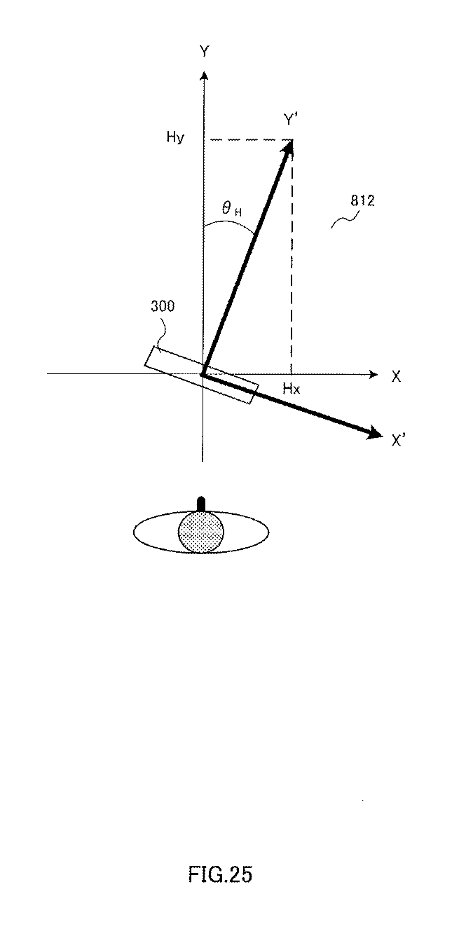

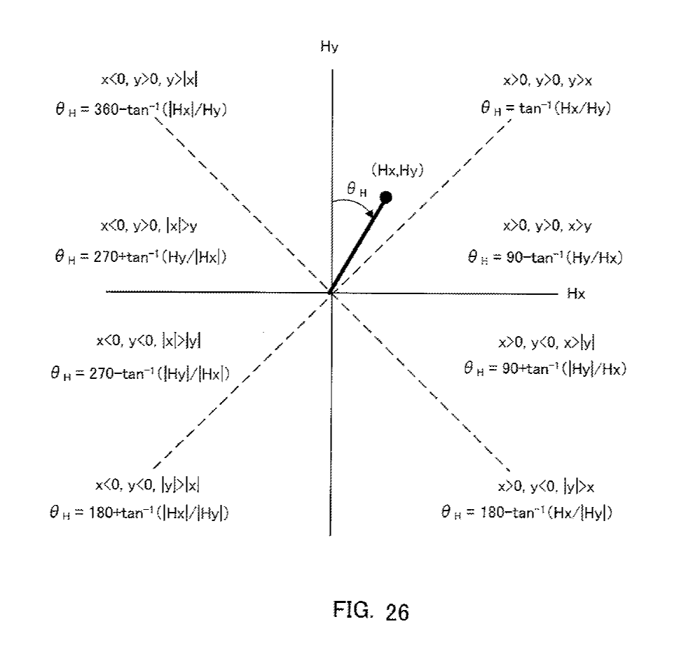

FIG. 25 shows the definition of apparatus azimuth θ_{H}, FIG. 26 shows an example algorithm of apparatus azimuth θ_{H}.

As shown in FIG. 25, apparatus azimuth θ_{H} represents the angle between Y-axis direction Y′ in the terminal coordinate system and the Y-axis positive direction on an XY plane in world coordinate system 812, for example. Apparatus azimuth θ_{H} has a positive value in the clockwise direction as seen in the vertical direction, for example.

Apparatus azimuth calculating section 760 outputs apparatus azimuth θ_{H} to walking azimuth calculating section 770.

In step S2200 of FIG. 8, walking azimuth calculating section 770 performs a walking azimuth calculating process of calculating walking azimuth θ.

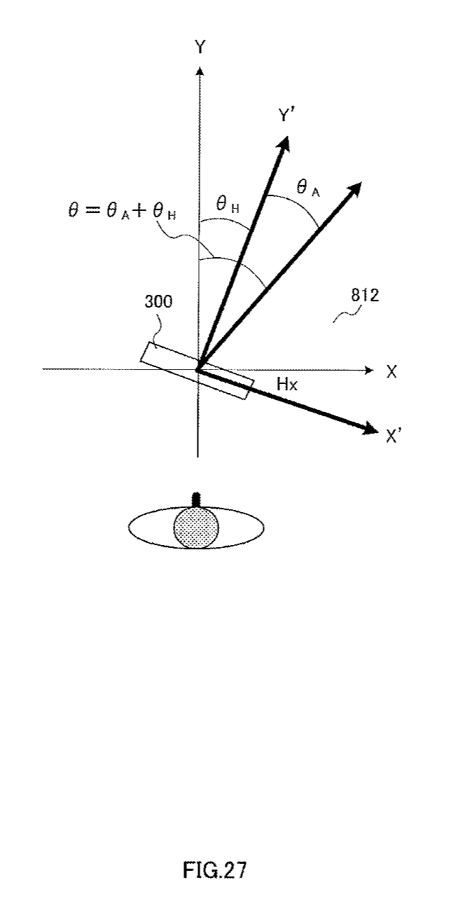

FIG. 27 shows the definition of walking azimuth θ and an example algorithm thereof.

Walking azimuth θ is defined by an angle from Y-axis positive direction on XY plane of world coordinate system 812, for example.

Walking azimuth θ has a positive value in the clockwise, direction as seen in the vertical direction, for example. Walking azimuth calculating section 770 adds apparatus azimuth in the world coordinate system and walking direction θ_{A} in the terminal coordinate system, for example, and thus calculates walking azimuth θ. Walking azimuth calculating section 770 outputs walking azimuth θ to output content generating section 330.

When completing the process is indicated (S1800: YES), stopped-state determining section 751 completes the sequence of processes.

By this means, walking azimuth detecting apparatus 700 can detect the walking azimuth of pedestrian 200 when the vertical component of the acceleration of pedestrian 200 reaches a local minimum value immediately after pedestrian 200 is in the stopped state.

As described above, walking azimuth detecting apparatus 700 according to the present embodiment determines that the azimuth of the acceleration of pedestrian 200 is the walking azimuth when the vertical component of the acceleration of pedestrian 200 reaches the local minimum value immediately after pedestrian 200 is in the stopped state. Consequently, walking azimuth detecting apparatus 700 can detect the walking azimuth to which pedestrian 200 starts walking, earlier and more precisely than conventional techniques.

In addition, walking azimuth detecting apparatus 700 according to the present embodiment detects the walking azimuth provided that the vertical component of the acceleration of pedestrian 200 reaches the local maximum value immediately after reaching the local minimum value. Consequently, walking azimuth detecting apparatus 700 can improve the detection accuracy.

### Embodiment 2

The inventor has found that the phenomenon in which vertical component Az reaches a local maximum point and a local minimum point in this order immediately after the above minute fluctuation interval is also characteristic at the start of walking, in the present embodiment. A walking azimuth detecting apparatus according to Embodiment 2 of the claimed invention detects a walking azimuth when detecting such a phenomenon.

The walking azimuth detecting apparatus according to the present embodiment has the same configuration as walking azimuth detecting apparatus 700 according to Embodiment 1, except only a walk-starting determining process in walk-starting determining section 752. Thus, the present embodiment will only explain a walk-starting determining process that differs from walking azimuth detecting apparatus 700 according to Embodiment 1.

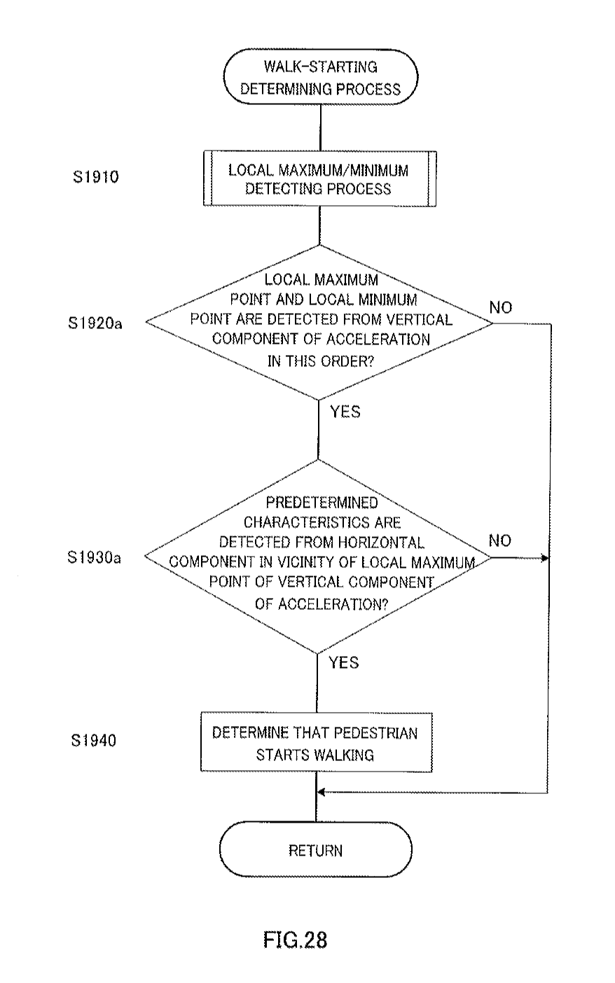

FIG. 28 shows an example walk-starting determining process according to the present embodiment and corresponds to FIG. 18 of Embodiment 1. The only difference between FIG. 28 and FIG. 18 is step S1920a.

In step S1920a, walk-starting determining section 752 determines whether or not a local maximum point and a local minimum point are detected in this order from vertical component Az of acceleration A. When the local maximum point and the local minimum point are detected in this order (S1920a: YES), walk-starting determining section 752 moves to step S1930a. When the local maximum point and the local minimum point are not detected in this order (S1920a: NO), walk-starting determining section 752 returns to the processes in FIG. 8.

In step S1930a, walk-starting determining section 752 determines whether or not the abode described predetermined characteristics are detected from horizontal component Axy of the acceleration in the vicinity of the local maximum point of vertical component Az of the acceleration. When the predetermined characteristics are detected from horizontal component Axy (S1930a: YES), walk-starting determining section 752 moves to step S1940. When the predetermined characteristics are not detected from horizontal component Axy (S1930a: NO), walk-starting determining section 752 returns to the processes in FIG. 8.

By this means, the walking azimuth detecting apparatus according to the present embodiment can early and precisely detect the walking azimuth to which pedestrian 200 starts walking.

The walking azimuth detecting apparatus according to the above explained embodiments may include the determinations of step S1930 in FIG. 18 and step S1930a in FIG. 28, in the determination of the stopped state. In other words, the walking azimuth detecting apparatus may determine that pedestrian 200 is in the stopped state provided that the above described predetermined characteristics are detected from the horizontal component of the acceleration.

In addition, the specific methods of, for example, acquiring each component of the acceleration of pedestrian 200, determining the stopped state, and determining the local maximum/minimum values, and the definitions of, for example, coordinate systems, and directions, are not limited to examples of the above described embodiments. The purpose of using the detected walking direction is also not limited to the above described examples.

The disclosure of Japanese Patent Application No. 2010-179487, filed on Aug. 10, 2010, including the specification, drawings and abstract, is incorporated herein by reference in its entirety.

### INDUSTRIAL APPLICABILITY

A walking azimuth detecting apparatus and a method of detecting a walking azimuth according to the claimed invention are useful since they can quickly and precisely detect a walking azimuth to which a pedestrian starts walking.

### REFERENCE SIGNS LIST

100 Warning system
200 Pedestrian
300 Mobile terminal
301 Housing
310 Radio communication section
320 Output section
330 Output content generating section
400 Structure
500 Base station
510 Radio communication section
520 Detection section
600 Movable body
700 Walking azimuth detecting apparatus
710 Acceleration measuring section
711 Acceleration sensor
720 Azimuth measuring section
721 Azimuth sensor
730 Acceleration component calculating section
731 Tilt angle calculating section
732 Vertical component calculating section
733 Horizontal component calculating section
740 Azimuth component calculating section
750 Walking direction calculating section
751 Stopped-state determining section
752 Walk-starting determining section
753 Walking angle calculating section
760 Apparatus azimuth calculating section
770 Walking azimuth calculating section

1-9. (canceled)

10. A walking azimuth detecting apparatus that detects a walking azimuth of a person, the apparatus comprising:
an acceleration component calculating section that acquires a vertical component and a horizontal component of acceleration of motion of the person; and
a walking azimuth calculating section that calculates the walking azimuth based on time series data of the vertical component and the horizontal component, wherein
the walking azimuth calculating section defines an azimuth of the horizontal component as the walking azimuth when a fluctuation in the horizontal component satisfies a predetermined condition during an interval from when the person is in a stopped state until the vertical component reaches a local minimum value for the first time, the azimuth of the horizontal component being obtained when the veritcal component reaches the local minimum value.

11. The walking azimuth detecting apparatus according to claim 10, wherein the predetermined condition is that the fluctuation in the horizontal component continues to be within a predetermined range during a predetermined time interval or more.

12. The walking azimuth detecting apparatus according to claim 10, wherein the predetermined condition is that the fluctuation in the horizontal component does not continue to be outside a predetermined range during a predetermined time interval or more.

13. The walking azimuth detecting apparatus according to claim 10, wherein the walking azimuth calculating section determines that the vertical component reaches a local minimum value provided that a difference of the vertical component based on a state at which the person is in the stopped state is a predetermined value or more.

14. The walking azimuth detecting apparatus according to claim 10, wherein the walking azimuth calculating section defines the azimuth of the horizontal component as the walking azimuth provided that the vertical component reaches a local maximum value immediately after the local minimum value.

15. The walking azimuth detecting apparatus according to claim 10, wherein the walking azimuth calculating section defines the azimuth of the horizontal component as the walking azimuth provided that the vertical component reaches a local maximum value immediately before the local minimum value.

16. The walking azimuth detecting apparatus according to claim 10, further comprising:
an acceleration sensor that is attached to a portable article of the person; and
an azimuth sensor, the positional relation of the azimuth sensor being fixed to the acceleration sensor, wherein:
the acceleration component calculating section calculates the vertical component and the horizontal component with reference to a result measured by the acceleration sensor and a result measured by the azimuth sensor; and
the walking azimuth calculating section calculates the azimuth of the horizontal component with reference to the result measured by the acceleration sensor and the result measured by the azimuth sensor.

17. The walking azimuth detecting apparatus according to claim 10, further comprising a radio communication section that transmits a result determined by the walking azimuth calculating section to an apparatus that uses the walking azimuth of the person, by radio.

18. A method of detecting a walking azimuth of a person, the method comprising the steps of:
acquiring a vertical component and a horizontal component of an acceleration of motion of the person;
determining that a fluctuation in the horizontal component satisfies a predetermined condition during an interval from when the person is in a stopped state until the vertical component first reaches the local minimum value, based on time series data of the vertical component and the horizontal component; and
determining that an azimuth of the horizontal component is the walking azimuth when the vertical component reaches the local minimum value.
